(19) United States
(12) Patent Application Publication
(10) Pub. No.: US 2018/0247161 A1
(43) Pub. Date: Aug. 30, 2018

(54) SYSTEM, METHOD AND APPARATUS FOR MACHINE LEARNING-ASSISTED IMAGE SCREENING FOR DISALLOWED CONTENT

(71) Applicant: Intaimate LLC, San Francisco, CA (US)

(72) Inventor: Don Kellogg Cowan, San Francisco, CA (US)

(21) Appl. No.: 15/934,769

(22) Filed: Mar. 23, 2018

Related U.S. Application Data
(60) Provisional application No. 62/449,563, filed on Jan. 23, 2017.

(51) Int. Cl. G06K 9/62; G06N 3/08; G06K 9/66

(52) U.S. Cl. CPC G06K 9/6262; G06K 9/66; G06N 3/08

(57) ABSTRACT

An adaptive screening system for disallowed content that includes a target image screening engine that targets images, detects and screens objects in the images and outputs results related to the screened objects and a neural network and model training engine that provides detection and screening parameters to the target image screening engine wherein the results related to the screened objects includes model performance data utilized by the neural network and model training engine to adjust the detection and screening parameters. Also included is an image management database for storing and retrieval of target images, detection and screening parameters, results related to the screened objects and model-related data.

### CROSS-REFERENCE TO RELATED APPLICATIONS

This application hereby claims the benefit of priority of U.S. Provisional Patent Application Ser. No. 62/449,563, filed on Jan. 23, 2017, entitled “SYSTEM, METHOD AND APPARATUS FOR MACHINE LEARNING-ASSISTED IMAGE SCREENING FOR DISALLOWED CONTENT,” and is herein incorporated by reference.

### BACKGROUND

Sharing of digital imagery, such as still, video and other modalities, is ubiquitous. Such sharing can help build and maintain beneficial human relationships. That said, there are certain situations where sharing is utilized in a manner such that it contains material that may perhaps not be optimal or perhaps in violation for rules and regulations when sharing is utilized in specific environments. Examples may include, but are not limited to, transmission of adult-type imagery, violence, derogatory references and threats.

To counter such non-optimal communications, a variety of techniques may be employed. These techniques, however, suffer from being typically too expensive and also lacking in a desired effectiveness which manifests itself, for example, via not detecting prohibited content and mistakenly flagging allowed content.

Due to the above-illustrated situation(s), there is a need and desire for improved methods and systems

Any examples of the related art and limitations described herein and related therewith are intended to be illustrative and not exclusive. Other limitations of the related art will become apparent to those of skill in the art upon a reading of the specification and a study of the drawings.

### SUMMARY

An adaptive screening system for disallowed content that includes a target image screening engine that targets images, detects and screens objects in the images and outputs results related to the screened objects and a neural network and model training engine that provides detection and screening parameters to the target image screening engine wherein the results related to the screened objects includes model performance data utilized by the neural network and model training engine to adjust the detection and screening parameters. Also included is an image management database for storing and retrieval of target images, detection and screening parameters, results related to the screened objects and model-related data.

The following embodiments and aspects thereof are described and illustrated in conjunction with systems, tools and methods which are meant to be exemplary and illustrative, not limiting in scope. In various embodiments, one or more prior art issues have been reduced or eliminated, while other embodiments are directed to other improvements.

### BRIEF DESCRIPTION OF THE DRAWINGS

Exemplary embodiments are illustrated in referenced figures of the drawings. It is intended that the embodiments and figures disclosed herein are to be considered illustrative rather than limiting. For easy reference, a copy of each figure is embedded in this disclosure at relevant locations. Additionally, a set of the same figures is also included with this disclosure.

FIG. 1 is a diagram illustrating a process overview of adaptive screening of disallowed and allowed images;

FIG. 2 is a diagram further illustrating adaptive screening data management, target image screening and neural networks & model training modules of FIG. 1;

FIG. 3 illustrates a screening results evaluation;

FIG. 4 is a diagram illustrating neural network model training processes and related structure;

FIG. 5 is a chart illustrating model training learning rates profiles;

FIG. 6 is a chart illustrating an example model training execution;

FIG. 7 is a diagram illustrating a neural network functional element summary;

FIG. 8 is a chart illustrating various neural network concepts;

FIG. 9 is a diagram illustrating a Softmax regression;

FIG. 10 is a diagram illustrating activation functions;

FIG. 11 illustrates how inputs are used for model training and inference processing to detect objects in the target;

FIG. 12 illustrates a process for re-shaping matrices;

FIG. 13 illustrates a matrix weighting process;

FIG. 14 illustrates applying weights using matrix multiplication;

FIG. 15 illustrates adding bias to a matrix;

FIG. 16 illustrates a rectified linear unit function;

FIG. 17 illustrates a logit function;

FIG. 18 illustrates a use of class labels;

FIG. 19 illustrates a convolution mechanism;

FIG. 20 illustrates using gradients to create a new node between tensors;

FIG. 21 illustrates a learning rate process used as an input for learning models;

FIG. 22 illustrates a stochastic gradient descent trainer process;

FIG. 23 illustrates a backward propagation process of output error feedback;

FIG. 24 illustrates a convolution process;

FIG. 25 illustrates a pooling process for reducing a size of a representation;

FIG. 26 illustrates a full connection state to activations in a previous layer;

FIG. 27 is a diagram illustrating a process of concatenating tensors along a dimension;

FIG. 28 is a diagram illustrating the use of dropout to achieve desired model accuracy and related model training efficiency;

FIG. 29 is a diagram illustrating neural network model training process & structure; and

FIG. 30 shows a diagram of an example computing system that may be used in accordance with the disclosed embodiments.

### BACKGROUND

A glossary of relevant terms may be found at Appendix A of this disclosure.

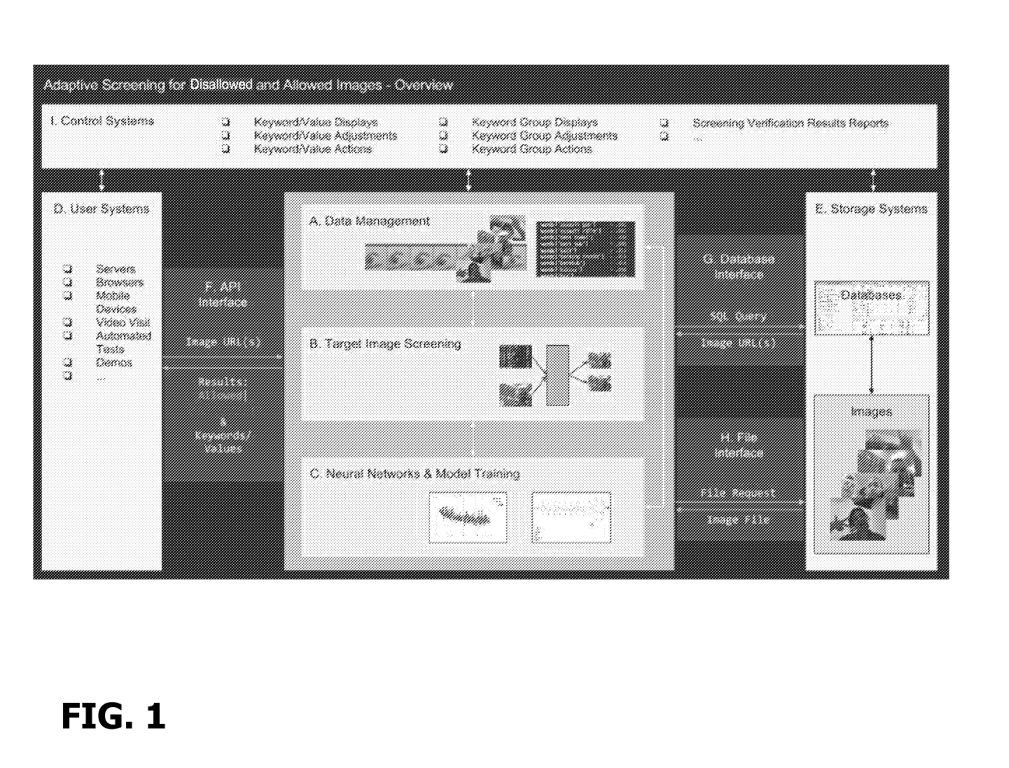

In reference to FIG. 1, this layer provides the management of data needed by the other layers of the system. This includes:

Object Image Generation: creation of JPEG files representing the objects to be detected in the target images.

Parameter Storage & Processing: managing parameters that are used to control aspects of the overall system.

Keywords/Values Storage & Processing: managing the keywords and associated probabilities that are associated with object types.

Screening Results Evaluation: processing the resulting success rates of target image screening.

[B.] Target Image Screening

This layer screens target images for the presence of objects and determines the probabilities that they are present. The final screening determination is whether the target image is Disallowed or Allowed based on an object keyword/value table. Target Image Screening includes:

Target Image Capture: Obtaining the image to be screened.

Object Detection: Determining what objects are present in the target image.

Object Evaluation: Determining the relative importance of objects based on screening keywords/values.

Target Image Final Screening: Making the final determination as to whether the target image is Disallowed or Allowed.

Target Image Screening Result Actions: Taking actions based on screening keywords/values and the final screening result.

[C.] Neural Networks & Model Training

This layer contains neural networks and processes for model training. Neural Networks include:

Object Recognition: used for detecting objects in a target image.

Keyword Evaluation: used for modifying object keywords/values based on screening results.

[D.] User Systems

These are example systems that may use the Image Screening service. This includes, but is not limited to:

Servers

Browsers

Mobile Devices

Video Visit

Automated Tests

Demos

[E.] Storage Systems

These are systems that typically store images and related information.

[F.] API Interface

This is the interface for typically sending an image screening request and receiving the screening result.

[G.] Database Interface

This is the interface for typically using SQL Queries to retrieve image URLs for model training.

[H.] File Interface

This is the interface for typically requesting and receiving an individual image.

[I.] Control Systems

Control Systems are typically used to monitor and manage the screening process.

Details

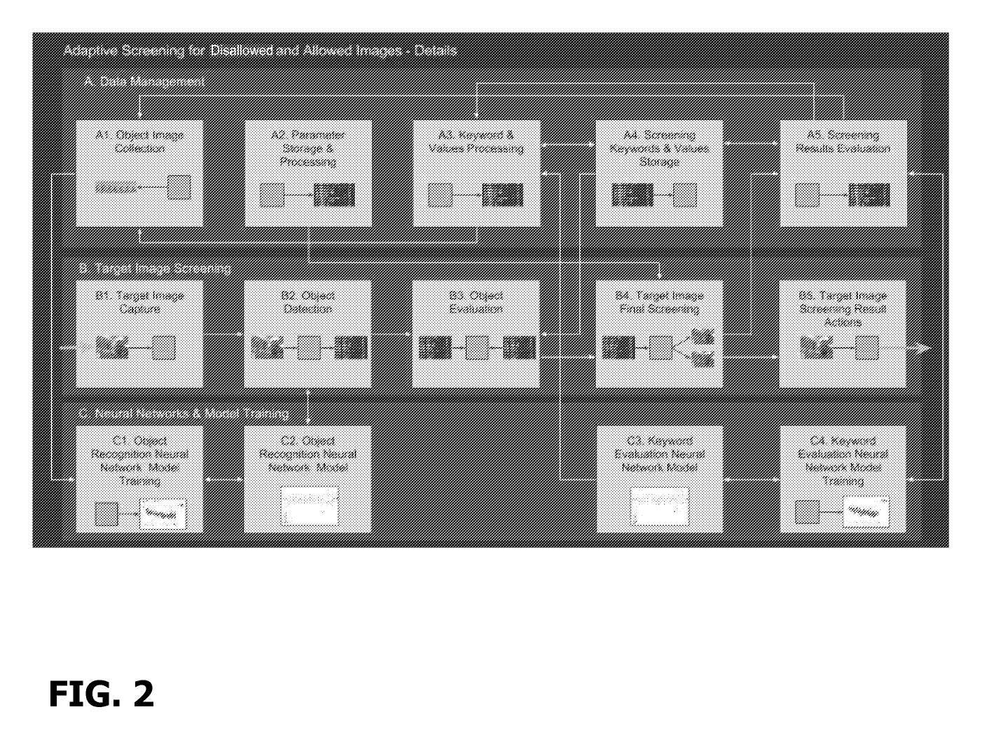

Referring to FIG. 2—Adaptive Screening Data Management, Target Image Screening and Neural Networks & Model Training—FIG. 2 includes

[A.] Data Management

This layer provides the management of data used by the components of the system.

[A1.] Object Image Collection

Object Images are JPEG encoded files that represent objects potentially located in screened target images. Object Images are used to train the Object Recognition Neural Network Model. Object images are collected from two main sources:

Images Retrieved from System Operations

These are images retrieved from the routine operation of the system using Adaptive Screening technology. Images are collected and then sorted into digital folders according to the object images they represent. For example, an image of a person making a threatening gesture might be put into a folder with the name threatening gesture.

Images Generated for Specific Objects

These are images generated using the following process:

Objects are video recorded moving in a variety of directions. For example, a specific gang sign formed with fingers is recorded while the hand making the sign rotates slowly.

Individual JPEG encoded frame files are pulled from the video.

The individual JPEG files are resized for uniform dimensionality.

The individual resized JPEG files are organized into appropriately named digital folders.

[A2.] Parameter Storage and Processing

There are a number of parameters used to control the operation of the Adaptive Screening system. These are stored, accessed and modified as needed. Parameters include:

Keyword Group Definitions

These parameters define groups of keywords. For example, a group of keywords/values can be weapons. The group of weapons keywords might include knives and guns.

Keyword Group Adjustments

These are percent positive and negative values that are applied to groups of keywords/values. The Keyword Group Adjustment would be use to increase or decrease the values associated with those keywords. A weapons +20% would increase the values of the weapons group by that amount.

Keyword/Group Actions

Keyword/Group Actions define the actions to be taken if a keyword or keyword group is detected as exceeding their defined minimum or maximum value. For example, for the weapons keyword group, if the allowed maximum value is exceeded, an action of stop communications might be designated.

[A3.] Keywords & Values Processing

Keyword/Value pairs are composed of:

Keyword: a string value describing an object, such as knife.

Value: a floating point number representing the probability that the associated object is present in a target image, such as 0.65.

Keyword/Value pairs are processed both internally and externally to the Image Screening System Python code:

Internal to Python Code: The Keyword/Value pairs are used to determine the maximum allowed values allowed for disallowed objects in a target image and the minimum allowed values for mandatory objects in target images.

External to Python Code: Keyword/Value pairs are modified using text editors.

[A4.] Screening Keywords & Values Storage

Keyword/Value pairs are stored in two types of tables:

Disallowed Objects: the value represents the maximum allowed probability that the associated keyword described object is present in the target image.

Mandatory Objects: the value represents the minimum allowed probability that the associated keyword described object is present in the target image

Keyword/Value tables are stored in two ways:

CSV (comma separated values) File Storage: These files are stored on devices external to the Image Screening System Python code. They can be accessed by multiple instances of the Image Screening System Python code.

Python Code Dictionary Internal Storage: Internal to the Image Screening System Python code, the Keyword/Values tables are represented as Python Dictionary data types.

[A5.] Screening Results Evaluation

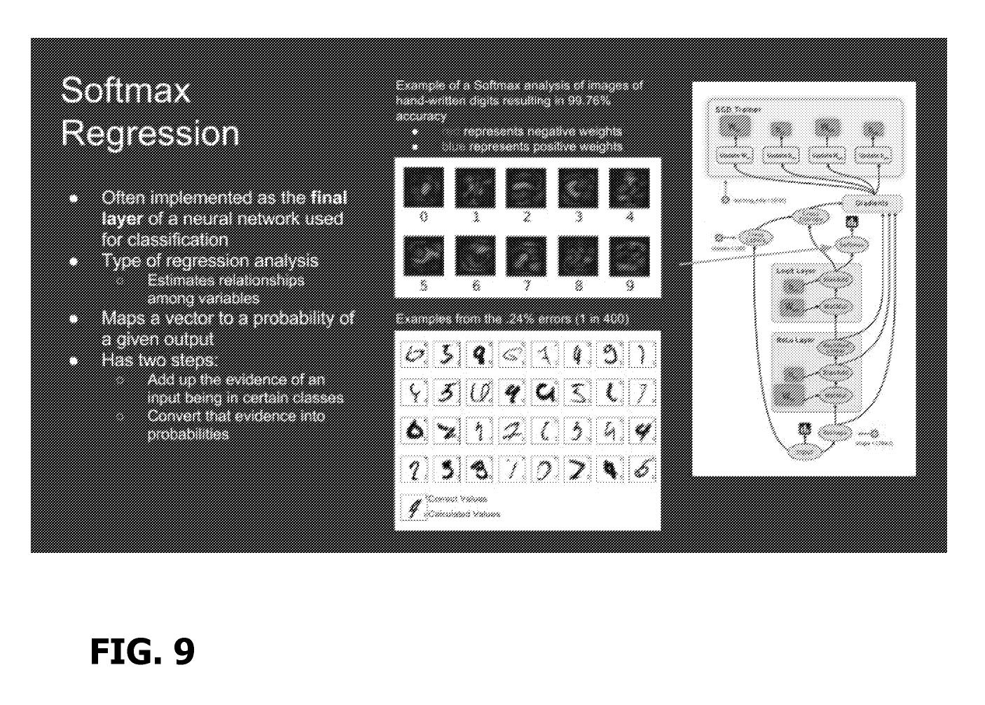

Screening results are periodically spot checked and evaluated to determine the level of accuracy of the final screening classification of Disallowed or Allowed. An Accuracy Percentage is assigned to groups of Keywords/Values. This information is used for refining Keywords/Values in order to improve the Accuracy Percentage. FIG. 9 show details of screening results evaluation involving the following:

[A5.1] Images Review Queue Database

Images are stored in a database with indicator for their Status and Verification Values.

[A5.2] Images Review Queue Database

Images are stop checked regularly to verify that the proper status classification has been performed by Target Image Final Screening. The Verification Value for the image is updated to accurate or inaccurate to indicate the result of a spot check.

[A5.3] Periodic Screening Verification Results Review

Review Queue data is periodically checked for recent Verification Values and a Verification Results Review Summary is prepared.

[A5.4] Periodic Screening Verification Results Review Summary

This summary indicates what types of images were found to have inaccurate Status Values. This information is then used by Neural Networks & Model Training to make appropriate updates.

[B.] Target Image Screening

This layer screens target images for the presence of objects and determines the probabilities that they are present. The final screening determination is whether the target image is Disallowed or Allowed based on an object keyword/value table.

[B1.] Target Image Capture

Target Images are captured by the Image Screening System using HTTP requests received by an Image Screening System server. After an image or images are received, object detection is performed.

[B2.] Object Detection

Object detection is performed via the Object Recognition Neural Network Model. Passing the Target Image through the Neural Network returns probability values for objects contained in the Target Image. For example, the following Keyword/Value pairs might be returned:

knife 0.036

gun 0.728

[B3.] Object Evaluation

Object Evaluation involves a process of comparing the Keyword/Value pairs returned from Object Detection with the Keyword/Value pairs contained in the Screening Keywords/Values tables:

Screening Keyword/Value Adjustments: Individual Screening Keyword Values are adjusted based on Keyword Group Adjustment values. Values are adjusted up or down depending on the applicable Keyword Group Adjustment value.

Object Values to Screening Values Comparison: Each object value is compared to the matching screening value. A matching screening value may or may not be present in the Screening Keyword/Values table.

Disallowed or Allowed Determination: If the object value is greater than the value specified in the Disallowed Objects table, the object is marked Disallowed. If the object value is less than or equal to the value specified in the Disallowed Objects table, the object is marked Allowed.

Present or Absent Determination: If the object value is greater than the value specified in the Mandatory Objects table, the object is marked Present. If the object value is less than or equal to the value specified in the Mandatory Objects table, the object is marked Absent.

[B4.] Target Image Final Screening

The Target Image is determined to be Disallowed or Allowed according to the following criteria:

Disallowed: If any object keyword marked Disallowed or Absent.

Allowed: If no object keyword marked Disallowed or Absent.

This is determined by processing Target Image Object Evaluation results.

[B5.] Target Image Screening Results Actions

Actions taken include:

Returning the Result to the HTTP Request Sender

Results returned include:

Classification of Disallowed or Allowed

URL of the Target Image JPEG file

The keywords and associated values for any Disallowed or Absent objects.

Actions Specified in System Parameters

[C.] Neural Networks & Model Training

This layer contains neural networks and processes for model training.

[C1.] Object Recognition Neural Network Model Training

Training the neural network model to recognize objects in a target image involves the following components:

Model Training Process & Structure

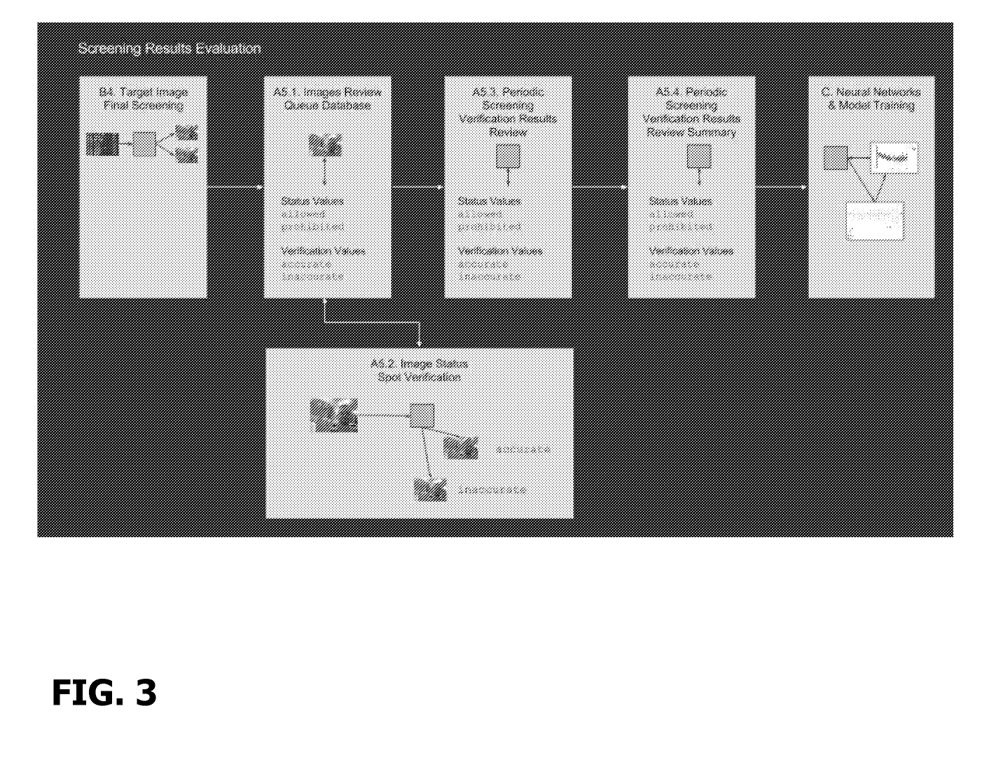

FIG. 3 shows the training process & structure elements. In summary, the training process makes multiple passes through the neural network code using training object images to improve the accuracy of model identification of objects in a target image. Model accuracy is also referred to as loss, which expresses the degree of incorrectness of a solution.

The training process is divided into Epochs, Steps and Learning Rate Decays:

Epoch: the execution of a number of Steps to process all the training image data files.

Step: Processes a batch of training image data files using a batch size and making one pass through the neural network model.

Learning Rate Decay: reduces the learning rate to prevent converging on a model accuracy above the optimal level.

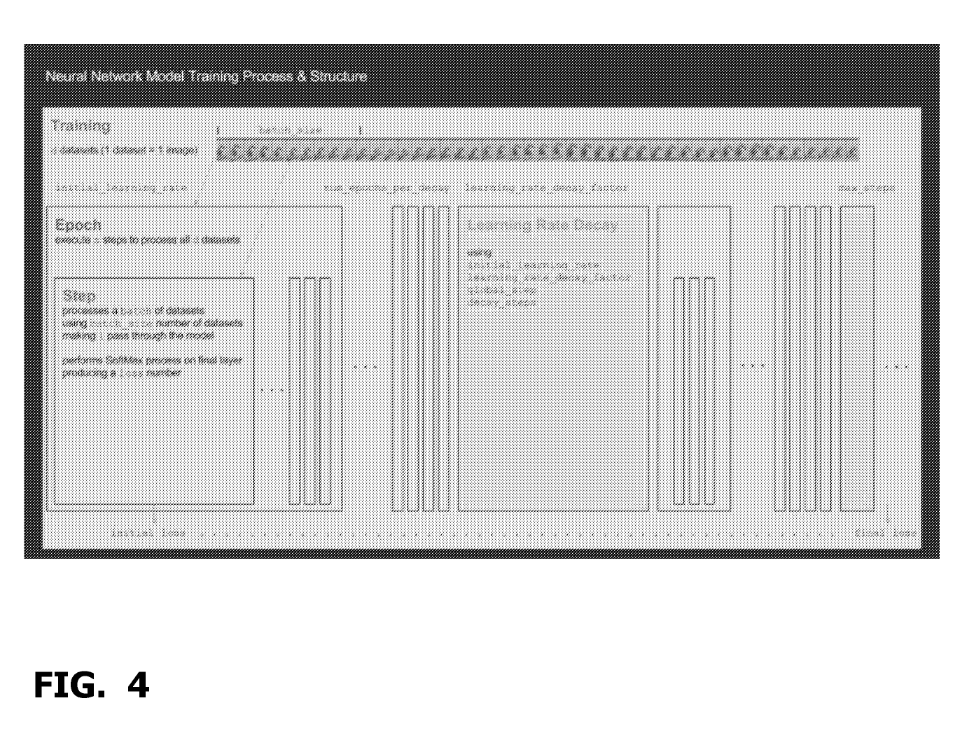

FIG. 4. Includes Neural Network Model Training Process & Structure.

Identifying Training Image Folders

Each folder contains the Object Images that will be used to train the neural network for the object identified by the name of the folder. For example, the folder named knife would contain images of knives.

Fine Tuning Learning Rate Parameters

Parameters include:

Initial Learning Rate: The initial rate of change for reducing model errors. The learning rate Controls the magnitude of the updates to the final layer. Intuitively if this is smaller the learning will take longer, but it can end up helping the overall precision. That's not always the case though, so you need to experiment carefully to see what works for your case.

Number of Epochs per Rate Decay: An epoch is one pass over the entire set of data. This parameter indicates the number of epochs after which the learning rate is decayed.

Learning Rate Decay Factor: This factor is used in the following formula:

decay_rate=initial_learning_rate*learning_rate_decay_factor̂(global_step/decay_steps)

Achieving the Best Model Learning Rate and Minimizing the Final Loss Level

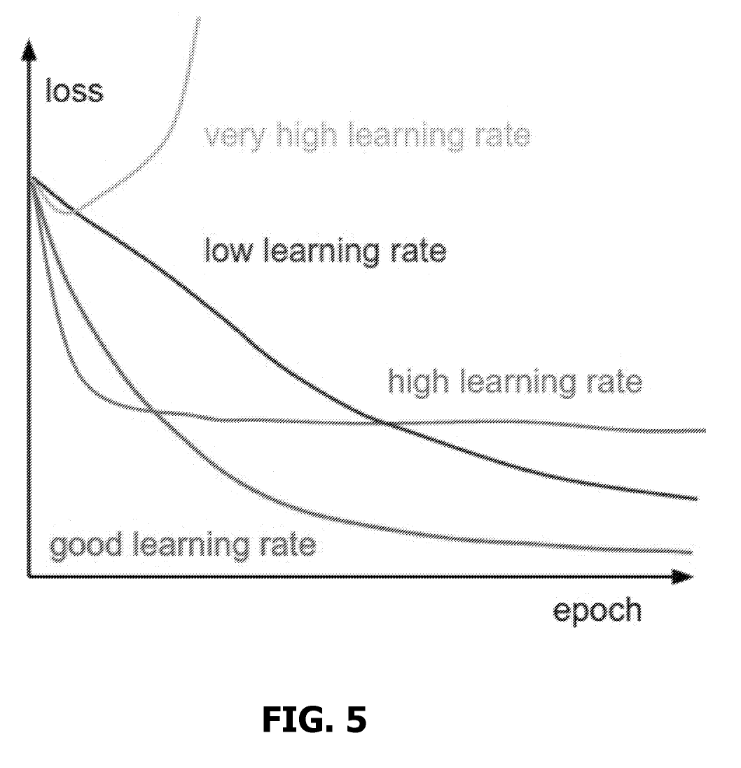

FIG. 5 depicts the change in loss over time during a model training. Learning rates that are too low or too high cause the model to never converge on an optimal loss (high accuracy) level. Learning rate parameters (see above) can be fine-tuned to achieve a good learning rate.

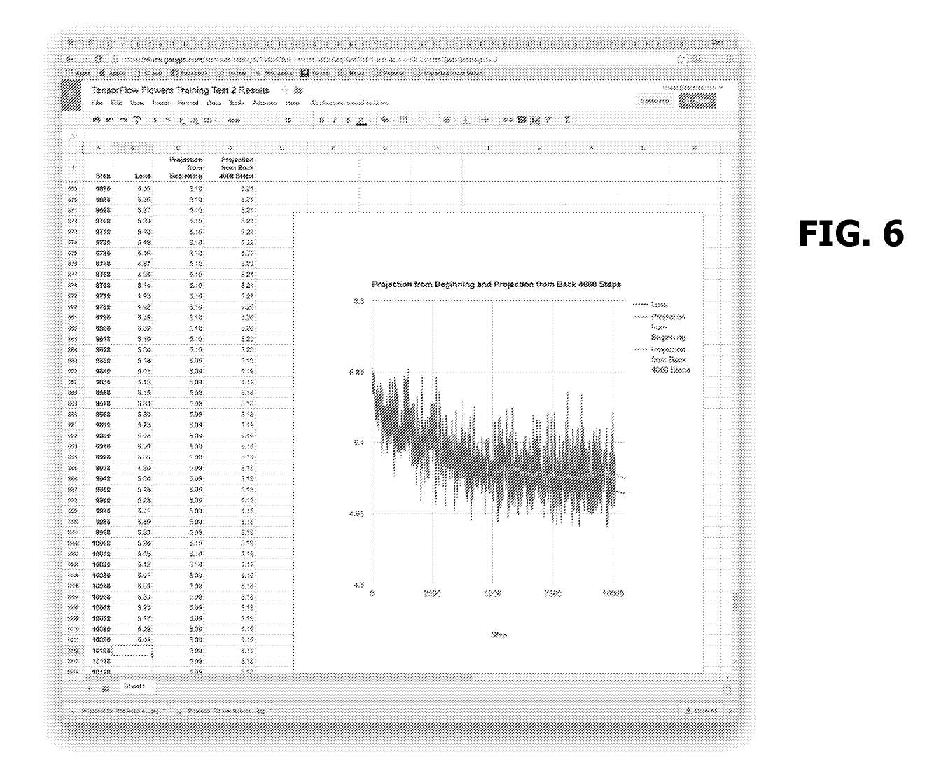

FIG. 6 depicts the result of a model training run with a learning rate that appears to be too high, as it is converging on a final loss well above the optimal target of close to zero.

[C2.] Object Recognition Neural Network Model

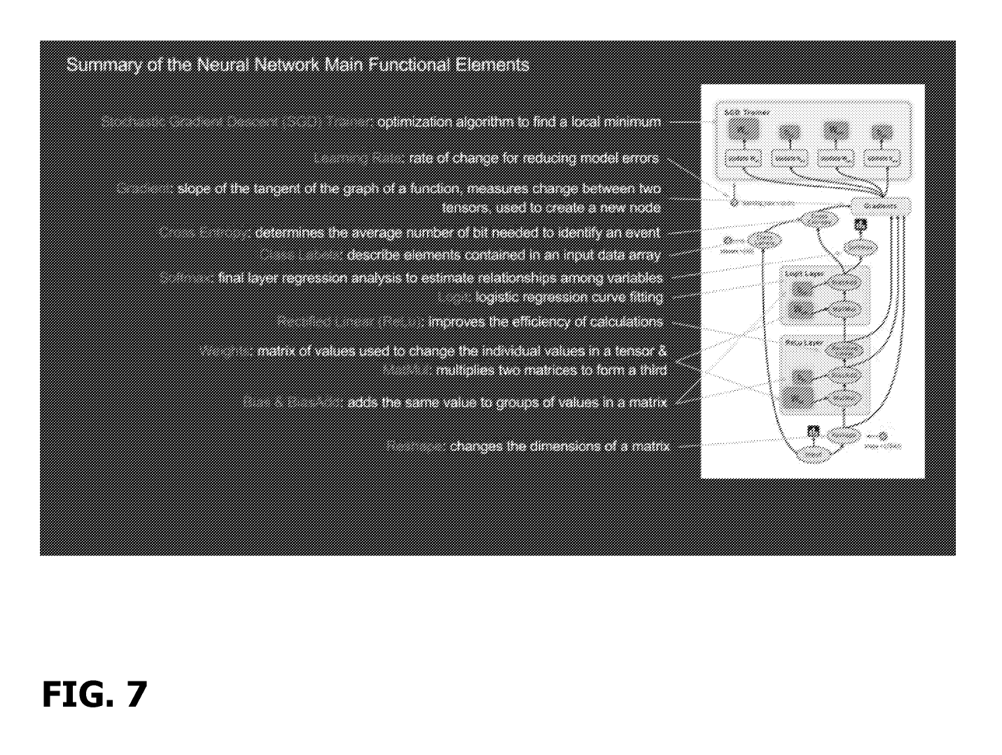

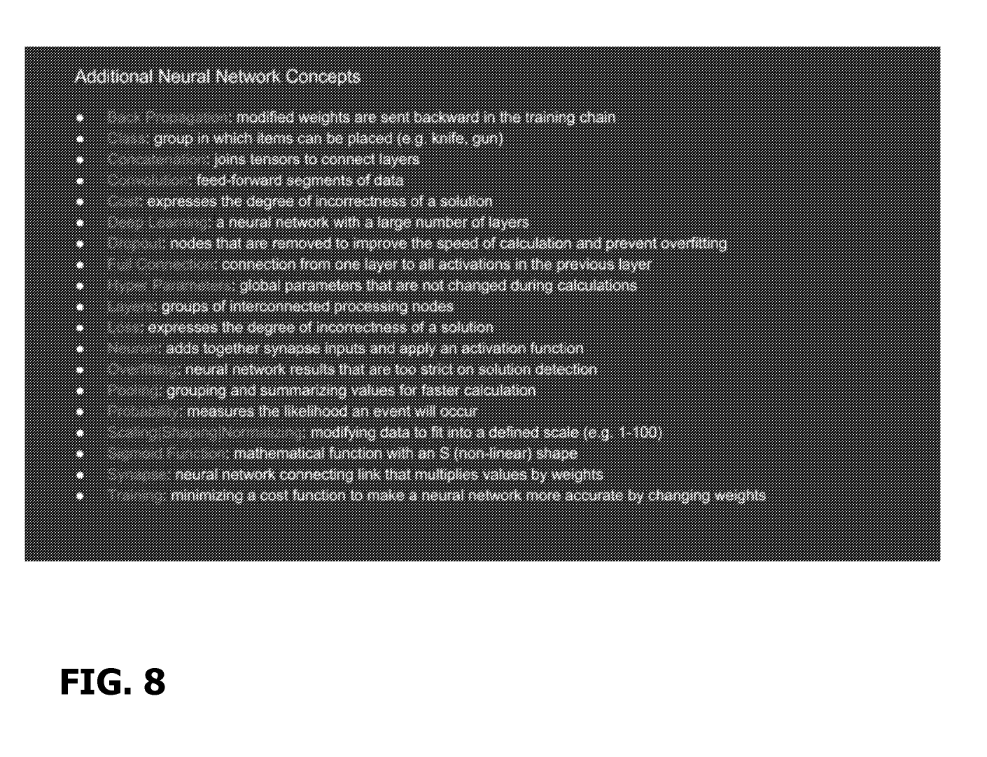

Main functional elements of the Neural Network Model are summarized in FIG. 7. Additional concepts are listed in FIG. 8.

The purpose of a neural network is to learn and then use that learning to predict. The neural network used for object recognition is based on the TensorFlow Inception-v3 deep convolutional neural network.

Learning

Through model training (see above) a neural network adjusts its internal weights and biases to achieve the best possible accuracy of predictions.

Prediction

Given an input, such as a target image JPEG file, the model outputs a prediction, such as the probabilities that the target image contains object images.

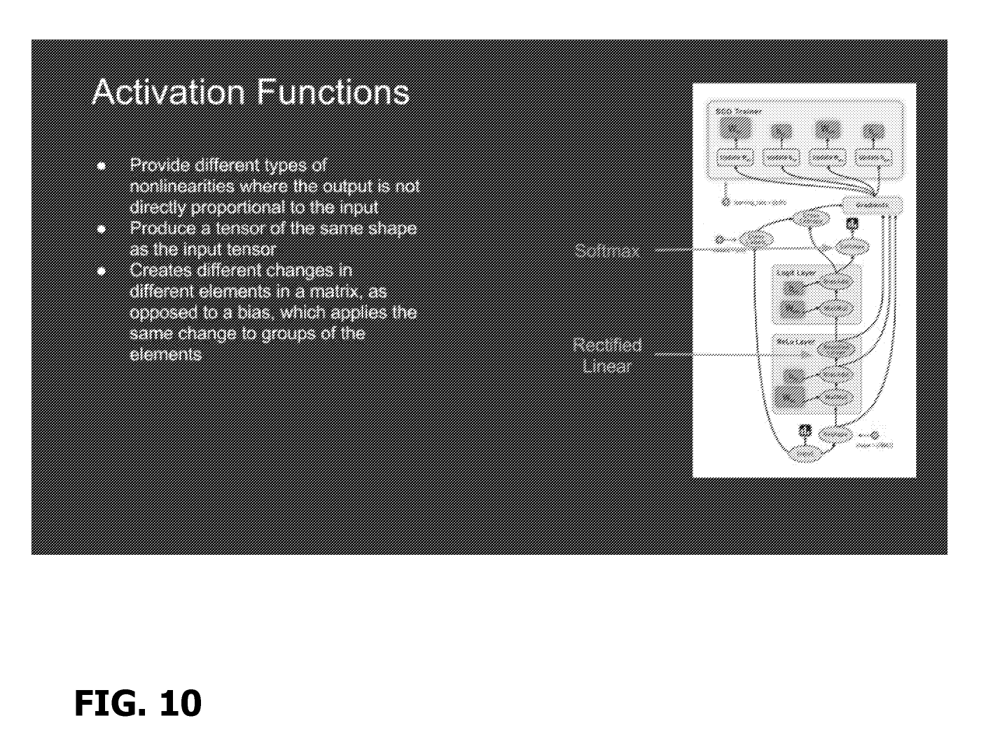

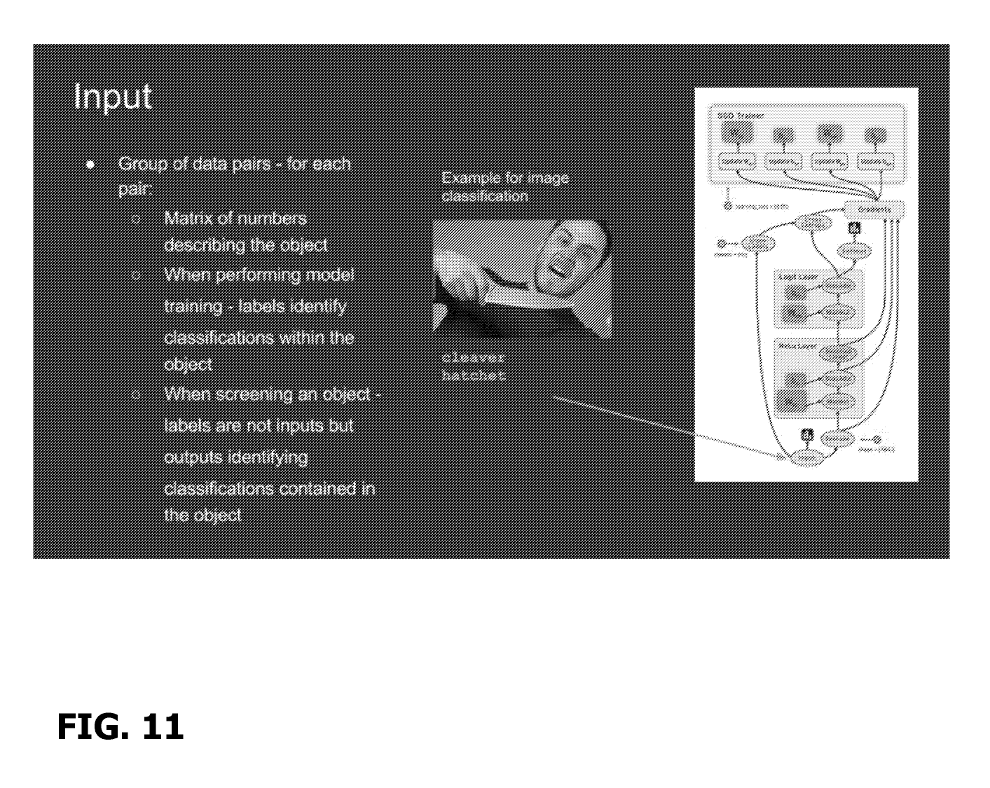

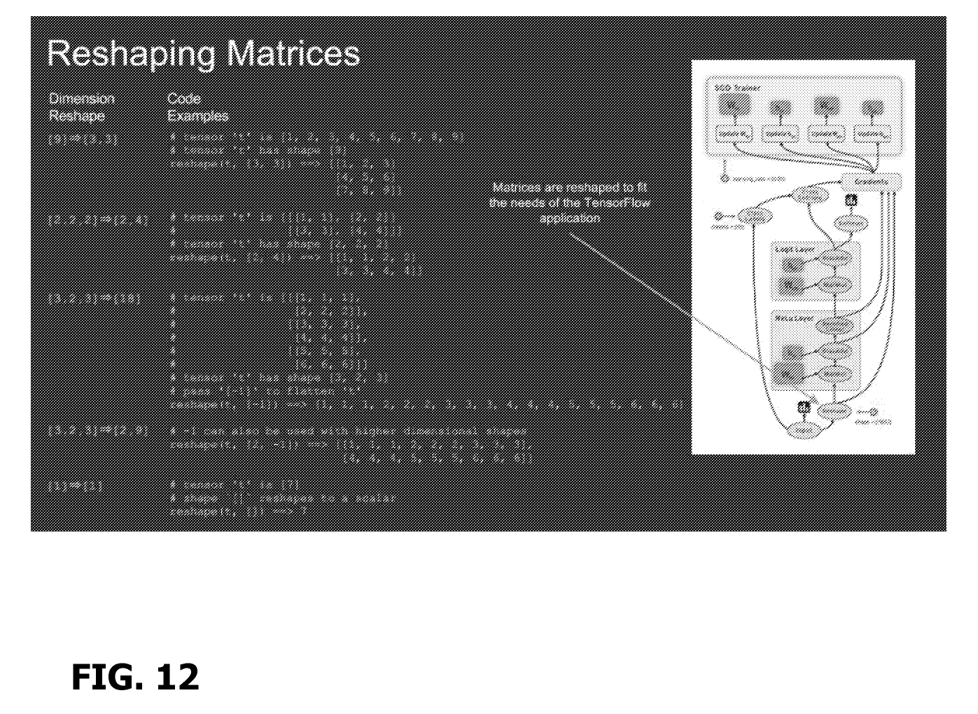

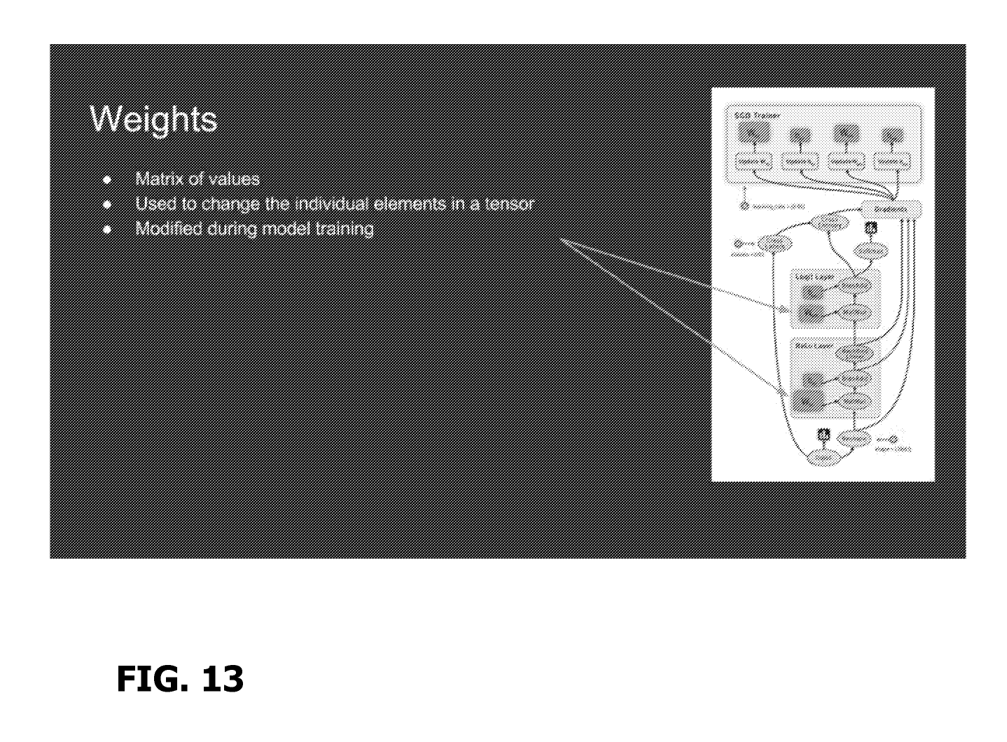

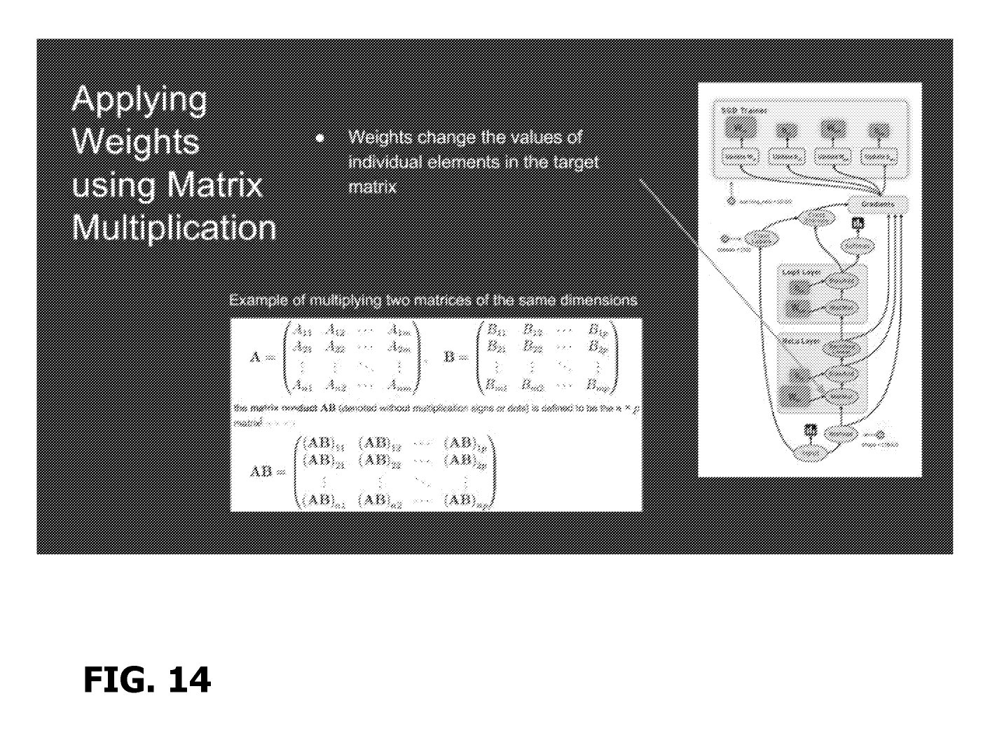

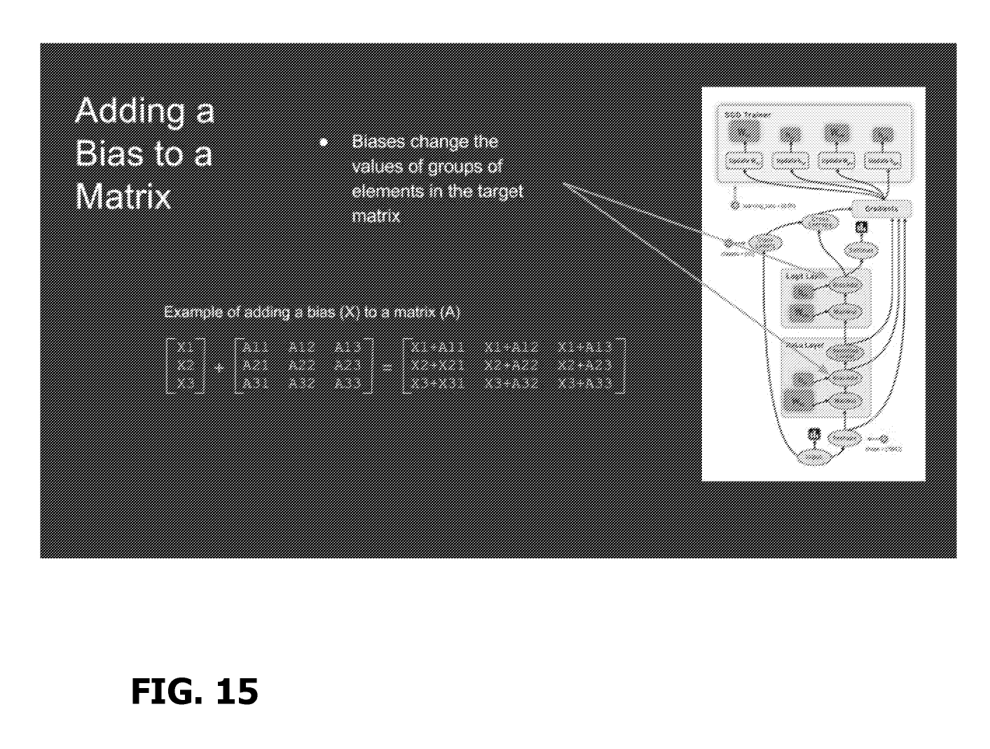

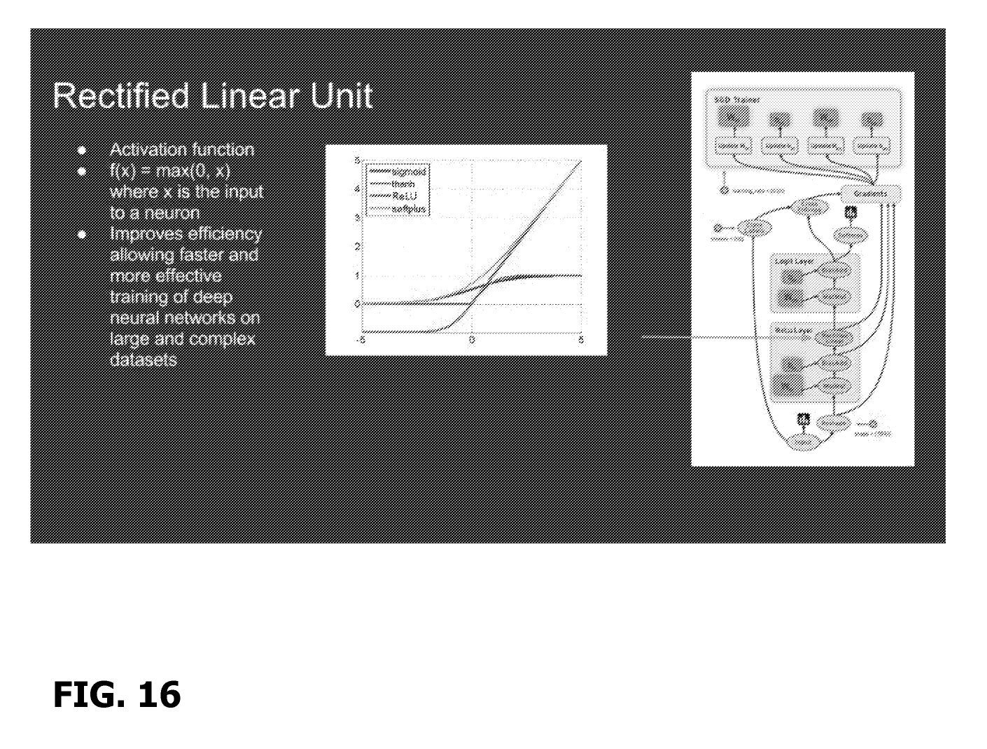

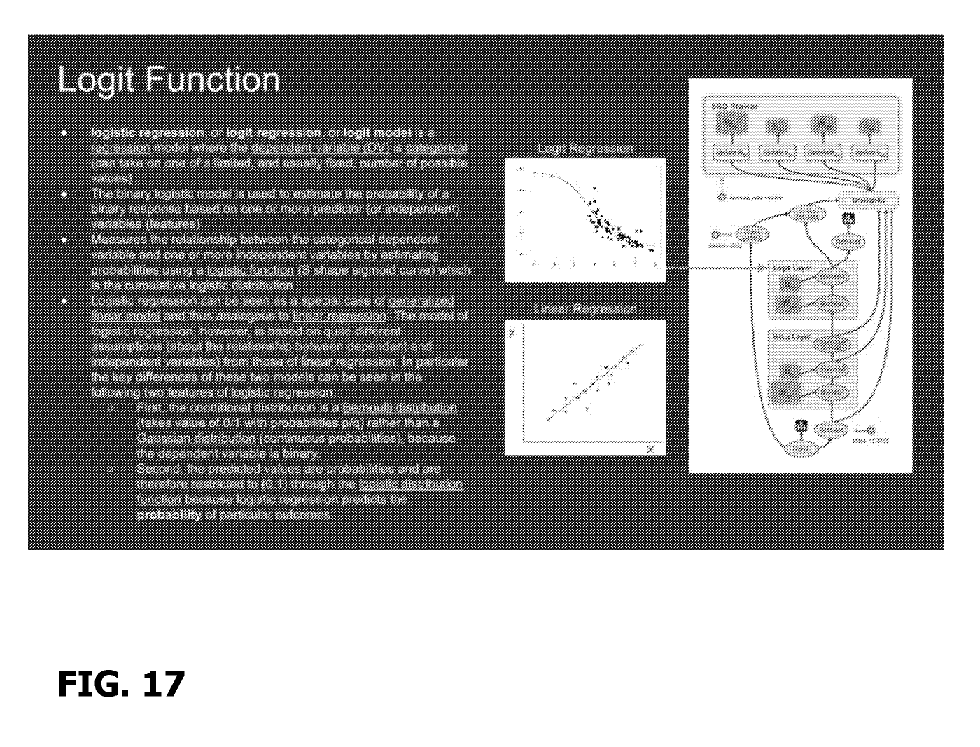

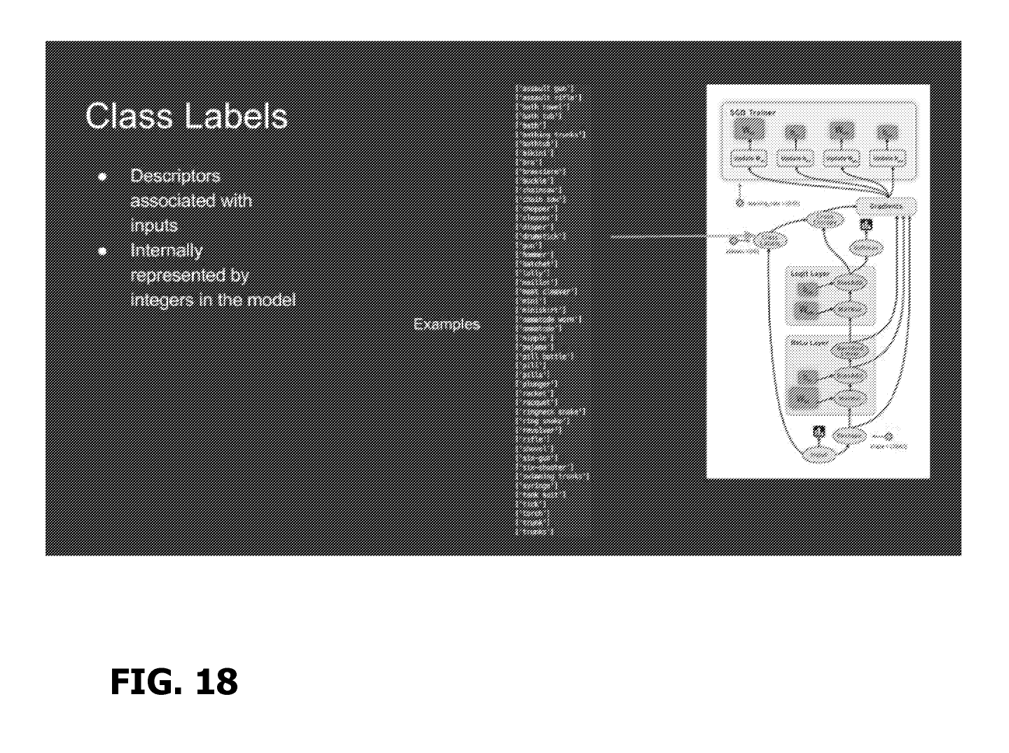

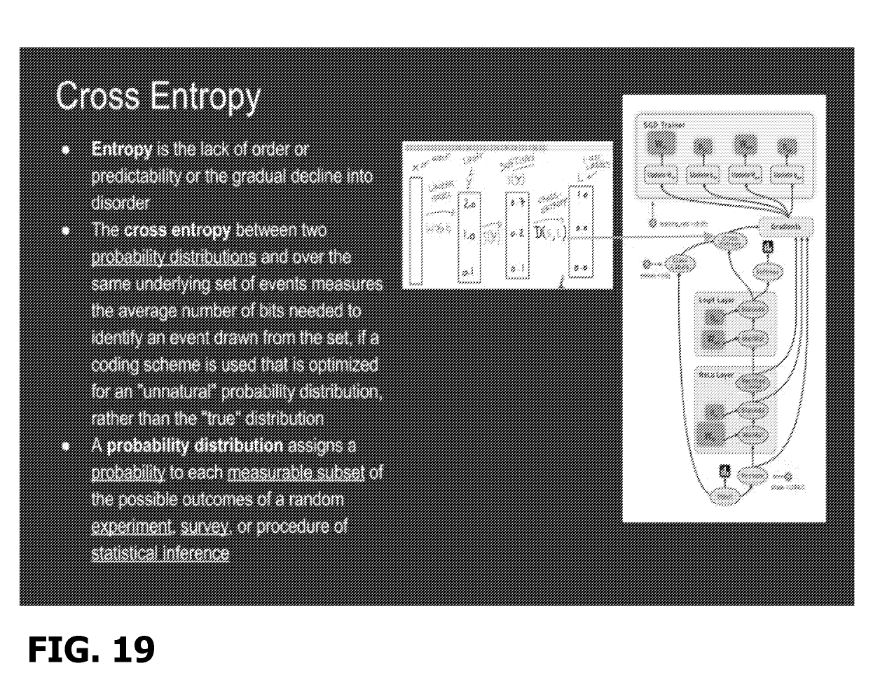

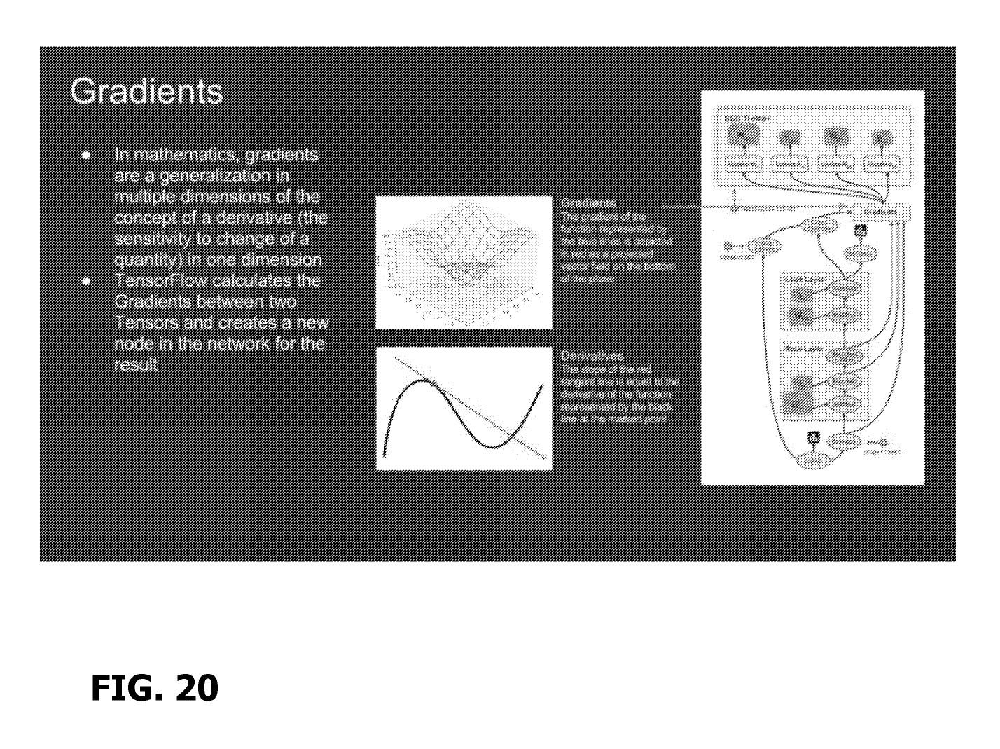

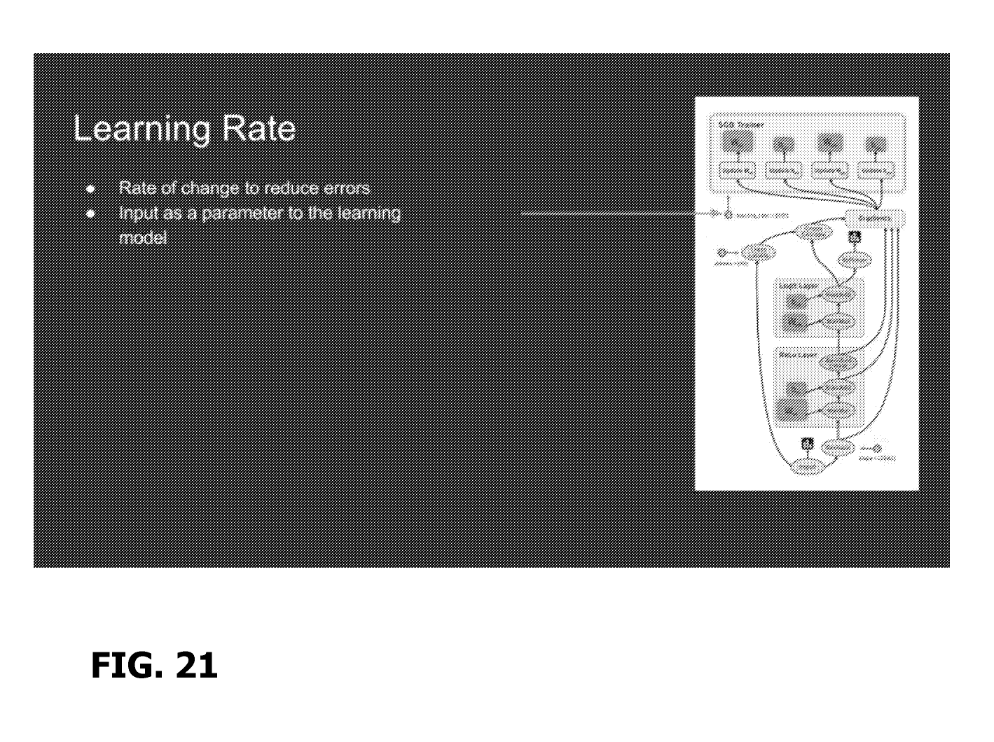

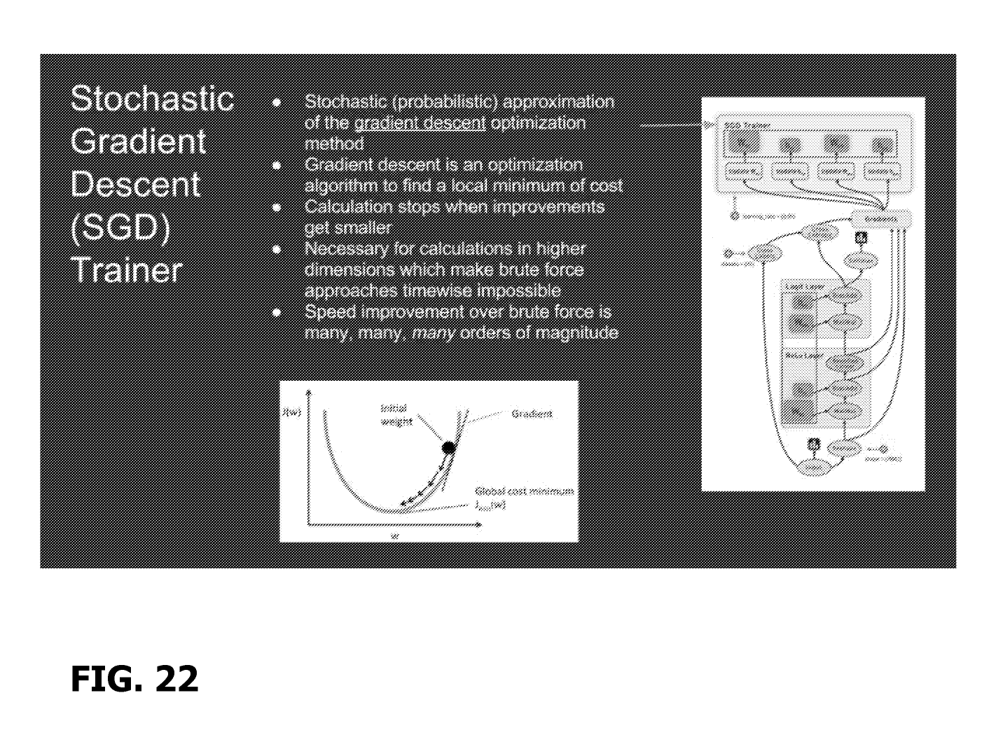

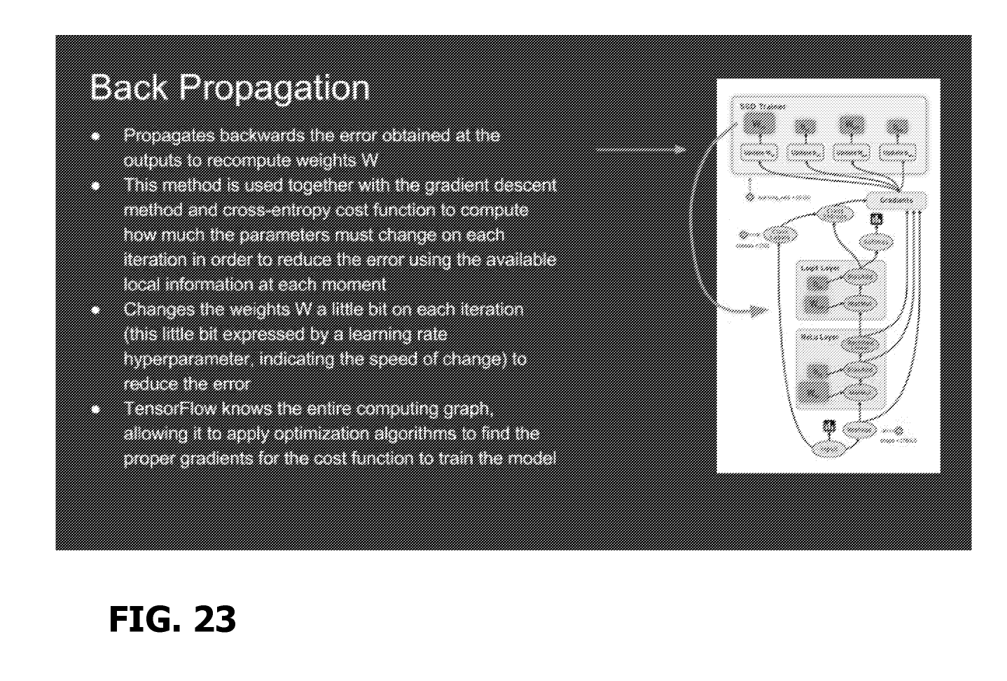

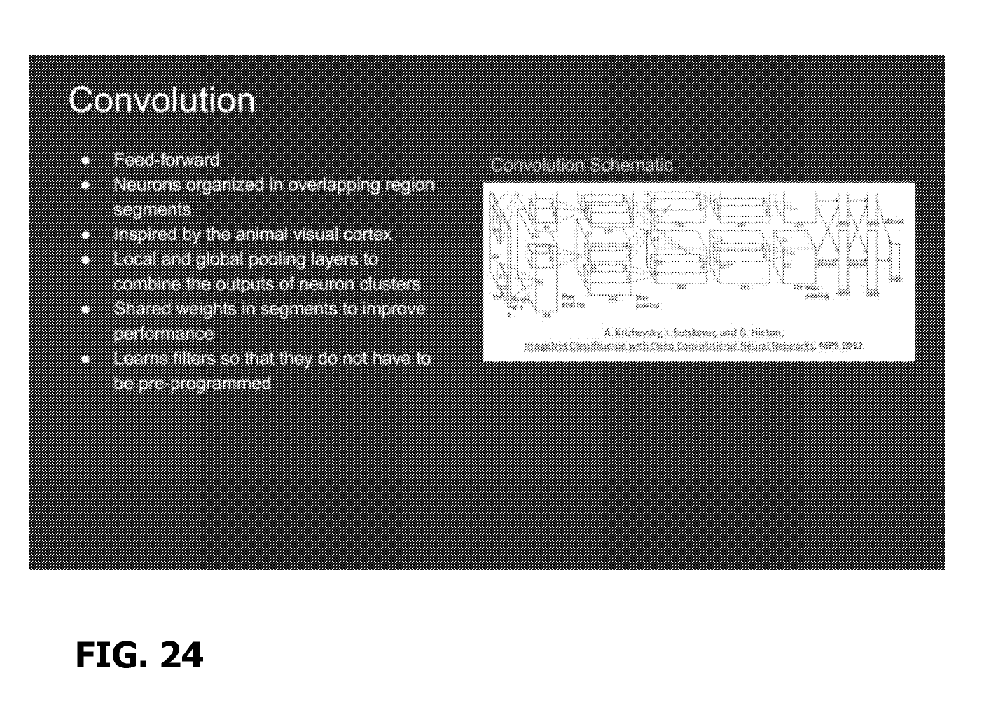

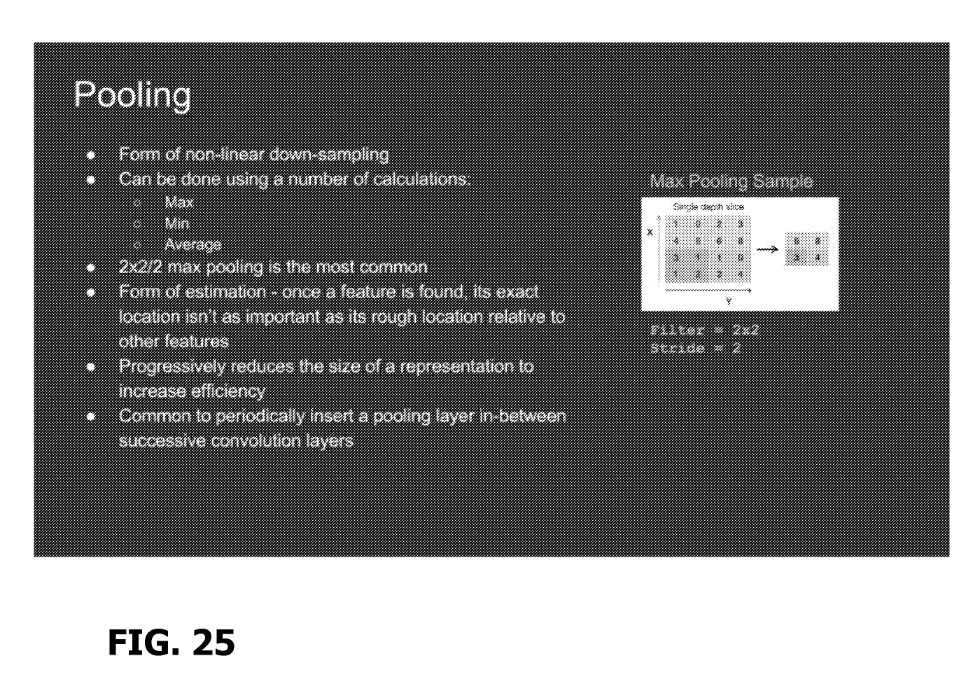

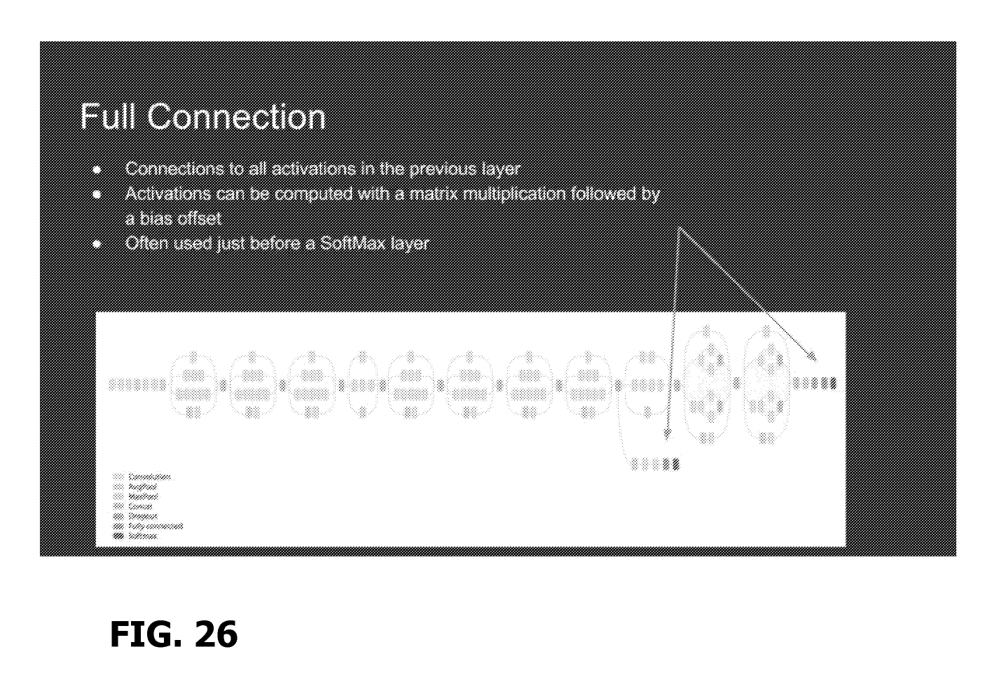

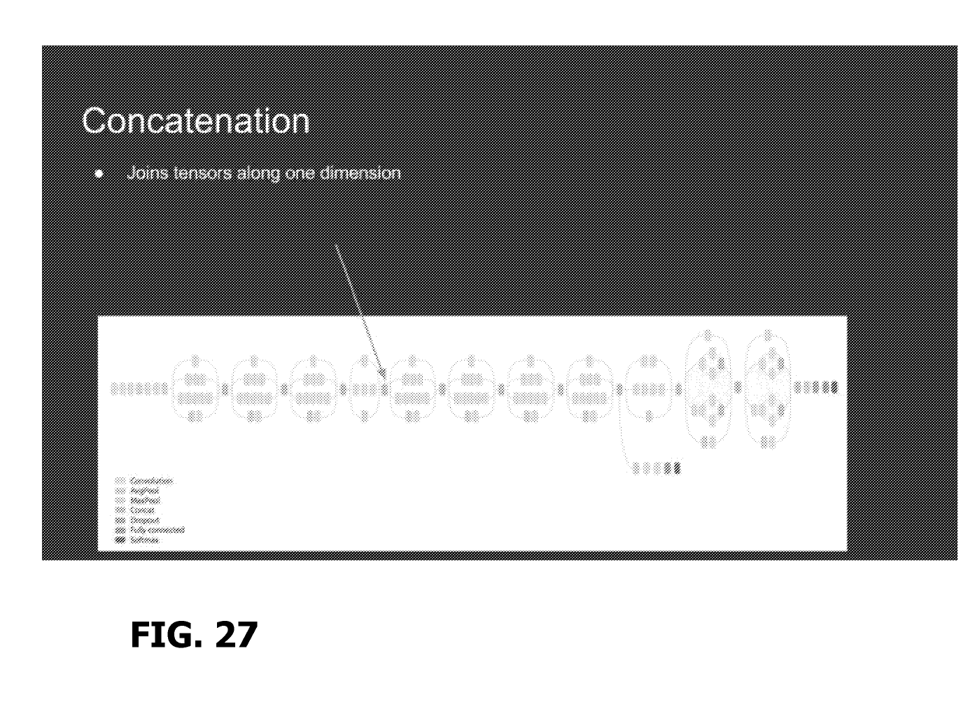

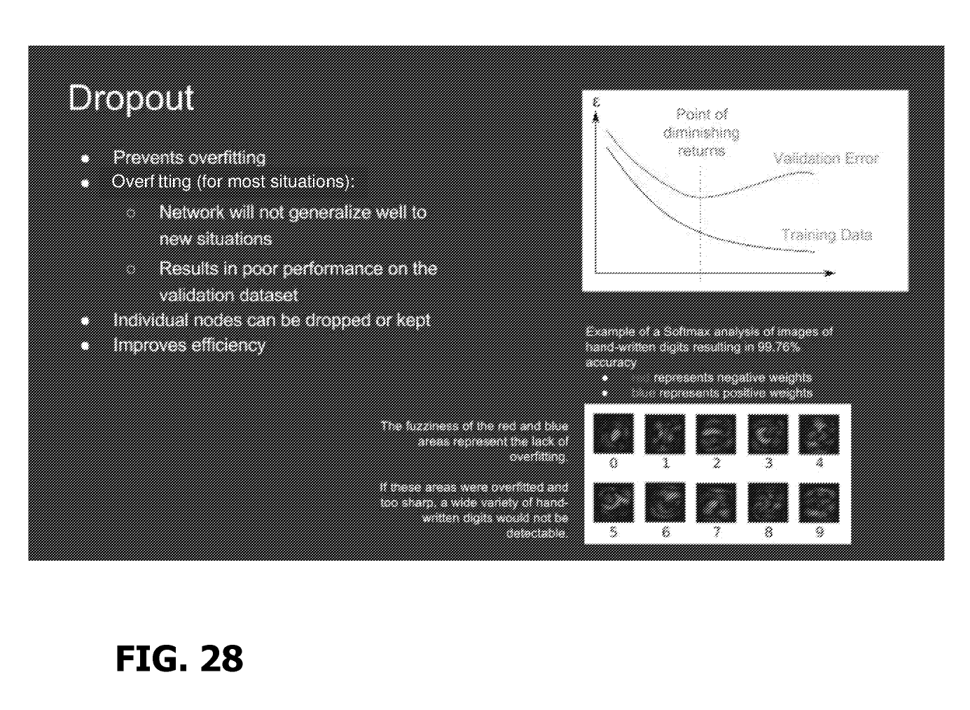

FIGS. 8-28 provide additional detail on Neural Network functional elements.

[C3.] Keyword Evaluation Neural Network Model

Main functional elements of the Neural Network Model are summarized in FIG. 4. Additional concepts are listed in FIG. 7.

The purpose of a neural network is to learn and then use that learning to predict. The neural network used for Keyword/Value learning is based on the TensorFlow Inception-v3 deep convolutional neural network.

Learning

Through model training (see above) a neural network adjusts its internal weights and biases to achieve the best possible accuracy of predictions.

Prediction

Given an input, such as Keywords/Values, the model outputs a prediction, such as the probabilities that a new list of Keywords/Values will achieve better results.

Referring back to FIG. 2's [C4.] Keyword Evaluation Neural Network Model Training:

Training the neural network model to recognize objects in a target image involves the following components:

Model Training Process & Structure

FIG. 8 shows the training process & structure elements. In summary, the training process makes multiple passes through the neural network code using training object images to improve the accuracy of model identification of optimal Keywords/Values combinations. Model accuracy is also referred to as loss, which expresses the degree of incorrectness of a solution.

The training process is divided into Epochs, Steps and Learning Rate Decays:

Epoch: the execution of a number of Steps to process all the training data files.

Step: Processes a batch of training image data files using a batch size and making one pass through the neural network model.

Learning Rate Decay: reduces the learning rate to prevent converging on a model accuracy above the optimal level.

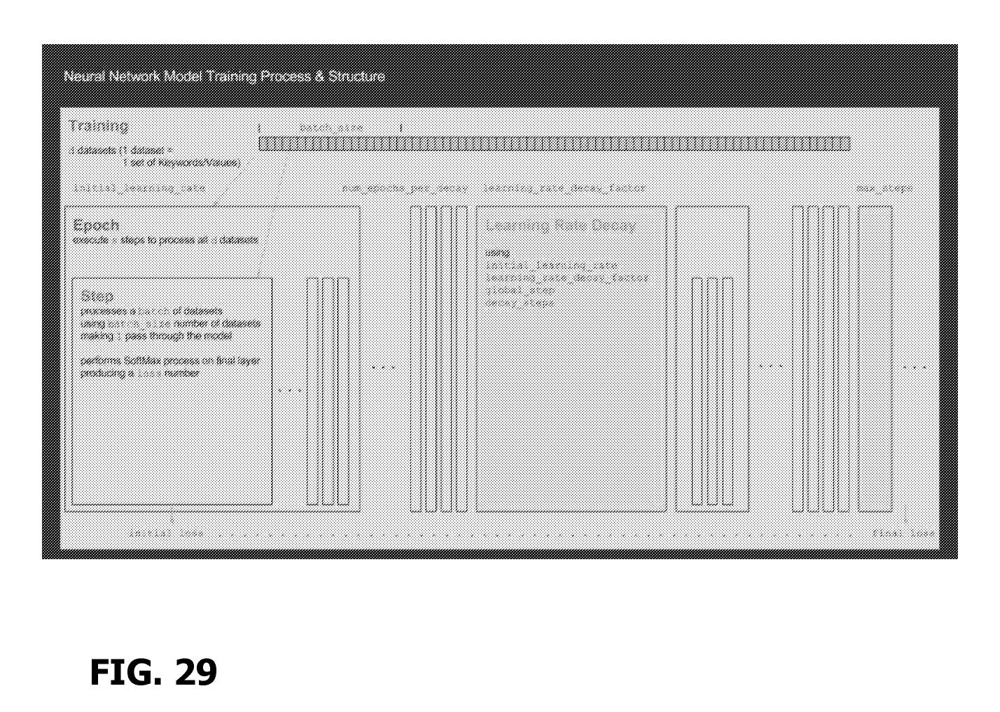

Referring to FIG. 29. Neural Network Model Training Process & Structure FIG. 29 includes;

Identifying Training Keywords/Values Folders

Each folder contains the Keywords/Values that will be used to train the neural network.

Fine Tuning Learning Rate Parameters

Parameters include:

Initial Learning Rate: The initial rate of change for reducing model errors. The learning rate Controls the magnitude of the updates to the final layer. Intuitively if this is smaller the learning will take longer, but it can end up helping the overall precision. That's not always the case though, so you need to experiment carefully to see what works for your case.

Number of Epochs per Rate Decay: An epoch is one pass over the entire set of data. This parameter indicates the number of epochs after which the learning rate is decayed.

Learning Rate Decay Factor: This factor is used in the following formula:

decay_rate=initial_learning_rate*learning_rate_decay_factor̂(global_step/decay_steps)

Achieving the Best Model Learning Rate and Minimizing the Final Loss Level

Referring back to FIG. 5, FIG. 5 depicts the change in loss over time during a model training. Learning rates that are too low or too high cause the model to never converge on an optimal loss (high accuracy) level. Learning rate parameters (see above) can be fine tuned to achieve a good learning rate.

[D.] User Systems

These are the systems that use the Image Screening service. This includes:

Servers

Browsers

Mobile Devices

Video Visit

Automated Tests

Demos

[E.] Storage Systems

These are systems that store images and information about them.

[F.] API Interface

This is the interface for sending an image screening request and receiving the screening result. The interface is implemented using HTTP GET requests.

HTTP GET Request

The syntax of an HTTP GET Request will vary by programming language. This is an example using the Python language:

```
  import requests
  get_response =
  requests.get(url=′http://imagescreening.com?image=http://files.recipeIm
ageGuard.com/kitchen/images/refimages/kitchen_advice/knives/
sharpening/sharpening
%20with%20stone/hold_knife.jpg′)
```

HTTP Response

This is a sample return JSON string:

[{″url″:″http://files.recipeImageGuard.com/kitchen/images/refimages/
kitchen_advice/knives/sharpening/sharpening%20with%20stone/hold_
knife.jpg″, ″keywords″: {″cleaver″: 0.35668, ″buckle″: 0.02102,
″meat cleaver″: 0.35668, ″hatchet″: 0.04538, ″chopper″:
0.35668}, ″result″: ″IMAGE DISALLOWED″}]

[G.] Database Interface

This is the interface for using SQL Queries to retrieve image URLs for model training. This is a sample database query:

```
  select
CONCAT(′https://media3.telmate.com/v2/photo/photo_photo/′,
encoded_id
* 2017)
  , case
  when approval_status = ″1″ then ″IMAGE ALLOWED″
  when approval_status = ″0″ then ″Pending″
  when approval_status = ″2″ then ″IMAGE DISALLOWED″
end as status
from
  (
  select a.id, photo_id + photo_reference_id as encoded_id,
approval_status from
  ( select p.id, (p.id *10000000) as photo_id,
cast(UNIX_TIMESTAMP( )/10000 as INT)
  as photo_reference_id, approval_status
  FROM production.photos p
  left join production.users u on p.user_id=u.id
  left join protocom.facilities f on f.id=u.facility_id
  where approval_status= 0 #Pending
  and (approval_status=1 #Approved
  or approval_status=2) #Denied
  limit 40
  ) a
  ) b;
```

[H.] File Interface

This is the interface for requesting and receiving an individual image. The syntax of reading or writing a file will vary by programming language. This is an example using the Python language:

import urllib
try:
response = urllib.urlretrieve(source)
except IOError, e:
print ″import_image: IO Error retrieving file: ″ + source
return 0
temp_file_location = response[0]
copyfile(temp_file_location, target_file_location)

[I.] Control Systems

Control Systems are used to monitor and manage the screening process.

Keyword/Value Displays

Displays keywords and their associated values, such as:

six-shooter, 0.002

torch, 0.024

syringe, 0.04

racket, 0.1

hammer, 0.05

meat cleaver, 0.2

revolver, 0.03

rifle, 0.002

cleaver, 0.2

Keyword/Value Adjustments

Provides capabilities to modify keywords and values, such as:

hammer, 0.05->hammer, 0.26

Keyword/Value Actions

Provides capabilities to specify actions to be taken when keyword/values reach targeted levels, such as:

hammer, 0.05->terminate video visit

Keyword Group Displays

Displays keyword groups and their associated adjustment values, such as:

weapons, 0%

uniforms, +10%

gang-signs, −5%

Keyword Group Adjustments

Provides capabilities to adjust keyword group adjustments, such as:

weapons, 0%->+5%

Keyword Group Actions

Provides capabilities to specify actions to be taken when keyword/values reach targeted levels, such as:

weapons, 0%->+10%

Screening Verification Results Report

Provides capabilities to specify actions to be taken when keyword/values reach targeted levels, such as:

weapons, 0%->+10%

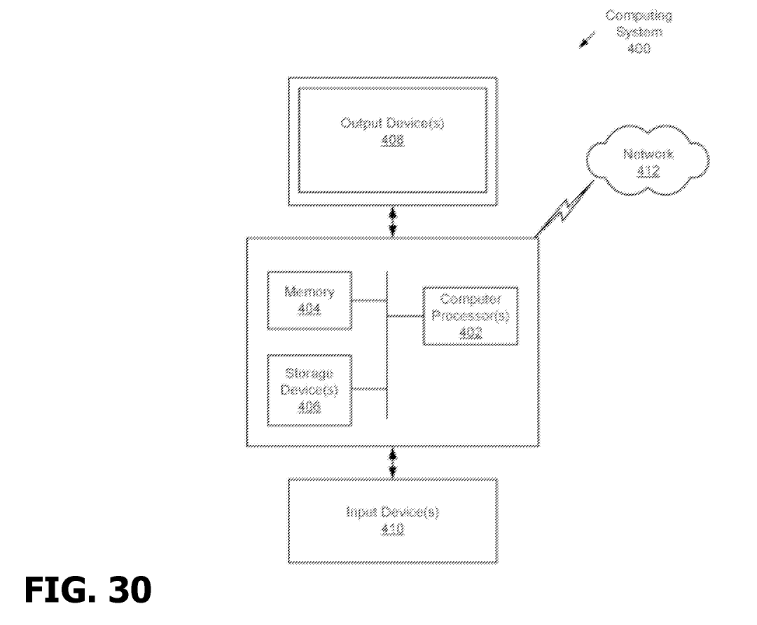

FIG. 30 shows a general computing system in accordance with at least one implementation of the claimed embodiments. As shown in FIG. 30, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, camera, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (414) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (414). Further, embodiments of the invention may be implemented on a distributed system having a plurality of nodes, where each portion of the invention may be located on a different node within the distributed system. In at least one implementation of the claimed embodiments, the node corresponds to a distinct computing device. Alternatively, the node may correspond to a computer processor with associated physical memory. The node may alternatively correspond to a computer processor or micro-core of a computer processor with shared memory and/or resources.

While a number of exemplary aspects and embodiments have been discussed above, those of skill in the art will recognize certain modifications, permutations, additions and sub-combinations thereof. It is therefore intended that claims hereafter introduced, are interpreted to include all such modifications, permutations, additions and sub-combinations as are within their true spirit and scope. It should also be understood that various terms and phrases utilized in this disclosure should be viewed in the context of what is being described as well how they are understood when used in related arts. As such, any otherwise conflicting definitions that may exist should not necessarily be assumed to be the intent of the inventor(s) of the various embodiments.

### Glossary

This glossary is being provided herein as a general guide to various aspects of this disclosure. Use of each entry should not necessarily be construed in a limiting fashion as the skilled artisan will readily recognize that various permutations can be had, from this disclosure, without departing from the scope of the disclosed embodiments.

Accuracy Percentage—a measure of the accuracy of a screening.

Image Screening System—a phrase, and variations thereof, to refer to the claimed embodiments.

Keywords/Values

These are pairs of text and integers that represent:

For objects that are disallowed, about the maximum allowed probability that the object is present in the target image being screened.

For objects that are mandatory, the minimum allowed probability that the object is present in the target image being screened.

Neural Network

A computing system the architecture of which is inspired by the central nervous systems of animals, in particular the brain. This system consists of layers of processing nodes containing approximation functions the output of which depends on large numbers of inputs.

Object Image

These are JPEG formatted files of depictions of objects that are either disallowed or allowed in the target images to be screened.

Object Recognition

The process of determining the probability that a given object image is present in the target image being screened.

Parameters

These are pairs of test and integers that represent parameters used to control the screening process. Parameters typically include:

The percent modification of a group of parameters that should be applied before screening.

The action to be taken if a target image is either disallowed or allowed.

Screening

The process of determining:

What objects are contained in an image

What the probabilities are that those objects are contained in the image

Based on those probabilities, whether the image should be classified as Disallowed or Allowed.

Target Image

The image being screened and classified as Disallowed or Allowed.

What is claimed is:

1. An adaptive screening system for disallowed content comprising:
a target image screening engine that targets images, detects and screens objects in the images and outputs results related to the screened objects;
a neural network and model training engine that provides detection and screening parameters to the target image screening engine wherein the results related to the screened objects includes model performance data utilized by the neural network and model training engine to adjust the detection and screening parameters; and
an image management database for storing and retrieval of target images, detection and screening parameters, results related to the screened objects and model-related data.
